(19) United States
(12) Patent Application Publication
(10) Pub. No.: US 2026/0125116 A1
(43) Pub. Date: May 7, 2026

(54) Heavy-Vehicle Mud Flap

(71) Applicant: Von Pace Wholesale Pty Ltd, Carrum Downs (AU)

(72) Inventor: Christian Von Schassen, Carrum Downs (AU)

(21) Appl. No.: 19/379,341

(22) Filed: Nov. 4, 2025

(30) Foreign Application Priority Data
Nov. 4, 2024 (AU) 2024903596

(51) Int. Cl. B62D 25/18

(52) U.S. Cl. CPC B62D 25/188

(57) ABSTRACT

A mud flap comprises an injection-molded unitary body of flexible rubber or polymer material including a mounting flange at the top that is adapted for securing the mud flap to a vehicle and a generally planar mud flap body depending from the mounting flange, the mud flap body having a front face formed with a pattern of parallel ribs extending in a diagonal orientation across the front surface. The body of the mud flap may be attached to the mounting flange by a joining region that has strengthening band with increased material thickness extending horizontally across the width of the mud flap. Increased stiffness can also be provided by optional vertical fins that may be formed on the front of the mud flap body, overlapping the same front surface carrying the diagonal ribs.

### CROSS REFERENCE TO RELATED APPLICATIONS

This application claims priority to Australian Application No. 2024903596 filed 4 Nov. 2024, the contents of which are incorporated herein by reference in their entirety.

### TECHNICAL FIELD

This invention relates to mud flaps and, in particular, to mud flaps for heavy vehicles such as trucks, semitrailers, articulated vehicles, and the like.

### BACKGROUND

Mud flaps are commonly employed on trucks and other large vehicles to block the spray of water, mud, and other debris from wheels on a wet roadway and prevent that spray from impairing the vision of the drivers of other vehicles. Indeed, in many jurisdictions the use of appropriate mud flaps on heavy vehicles is mandated, for the protection of other road users. Such flaps are typically in the form of relatively large, rectangular, deflecting panels which are hung vertically behind the wheels to block the spray and debris thrown up from the road surface.

In order to be effective in blocking spray and debris from a vehicle wheel, the mud flap must, at least substantially, remain in its vertical position behind the wheel, otherwise it presents a reduced barrier. That means the mud flap structure needs to have sufficient stiffness and/or weight to remain in place notwithstanding significant forces from wind currents and the like. Mud flaps with insufficient stiffness and/or weight are prone to “sailing”.

If the mud flap is made from a material is relatively stiff then water and debris impacting the mud flap is more likely to ricochet off the surface onto the roadway, which is undesirable. A mud flap made of a stiff material such as metal can be thin, strong and light, but ricochets are a concern and metal structures can be damaged by bending. Stiff non-metal materials, on the other hand, may be brittle and therefore not good against impacts and with respect to cracking around the mount. It should also be recognized that stiff mud flaps with no ‘give’ generally perform poorly in an aerodynamic sense, resulting in increased drag on the vehicle. It is known to combat aerodynamic drag by having mud flaps with holes/apertures to allow airflow through but not road debris. Such apertures can make the mud flap more susceptible to damage, however, unless advanced materials or composite structures are used—potentially increasing costs.

Mudflaps made from flexible materials can better absorb impacts and are less likely to sustain damage around the mounting flange from repeated bending of the mud flap in use. A common mud flap construction comprises an appropriately shaped (e.g. rectangular) piece of thick, flexible material, such as a thick rubber sheet. Thinner flexible materials can be used with metal stiffening structures but this can increase costs and the thinner material may be subject to damage from punctures and tears.

Usually, a mud flap is supported from a structure of the vehicle by a plurality of bolts, that extend through attachment holes formed adjacent the upper edge of the mud flap. Over a period of time, however, the mud flap can tend to fatigue and weaken, particularly around the area of the attachment holes and the nearby section of the flap, which can cause the mud flap to tear away from the bolts. Besides requiring replacement, the damaged mud flap can tear completely away from the vehicle while the vehicle is in use creating a significant risk of damage or injury.

Another problem that often occurs with many known mud flap designs is commonly referred to in the art as “sailing”. Sailing is the tendency of a mud flap to swing or flap rearwardly during forward movement of the vehicle, and can result in uncovering at least part of the wheel, thus allowing liquid, slush, rocks, etc. to be thrown rearwardly from the vehicle without obstruction. Efforts to reduce sailing of a mud flap may involve affixing rigid backing materials or inserting stiffening members in cavities of the mud flap. Other mud flap designs have apertures that allow air flow through. These approaches, however, are generally not fully satisfactory because they increase complexity in the manufacturing process, and therefore increase cost. Moreover, it is desirable that the mud flap retain sufficient flexibility and toughness so as to be able to withstand impacts, cold temperatures or the like.

With the foregoing as context, there is need for a mud flap for heavy vehicles and for other applications that resists tearing or cracking in the vicinity of the mounting structure, and that reduces the tendency of the mud flap to sail without excessively increasing the weight of the mud flap.

### SUMMARY

A mud flap according to one aspect of the invention comprises an injection-molded unitary body of flexible rubber or polymer material including a mounting flange at the top that is adapted for securing the mud flap to a vehicle and a generally planar mud flap body depending from the mounting flange, the mud flap body being attached to the mounting flange by a joining region that has strengthening band with increased material thickness extending horizontally across the width of the mud flap.

A mud flap according to another aspect of the invention comprises an injection-molded unitary body of flexible rubber or polymer material including a mounting flange at the top that is adapted for securing the mud flap to a vehicle and a generally planar mud flap body depending from the mounting flange, the mud flap body having a front face formed with a pattern of parallel ribs extending in a diagonal orientation across the front surface. In embodiments, the front of the mud flap body may have different diagonally oriented patterns of ribs on the left and right sides thereof. The left and right patterns of ribs may have mirror image symmetry. In embodiments, the mud flap body has a sheet material thickness, and the ribs protrude from the sheet material front surface to a height less than the sheet material thickness. In an exemplary embodiment, the height of the ribs may be about one half of the sheet material thickness. The ribs provide increased strength to the mud flap body, against impacts from the front and horizontal tearing for instance, and can also be employed to provide increased stiffness of the mud flap body to reduce sailing. The height, spacing and orientation of the rib pattern(s) may be selected accordingly.

Increased stiffness can also be provided by optional vertical fins that may be formed on the front of the mud flap body, overlapping the same front surface carrying the diagonal ribs. The fins project further from the surface of the mud flap body than do the ribs. In embodiments, the height of the fins is greater than the sheet material thickness of the mud flap body. The top ends of the vertical fins also overlap with the strengthening band near the mounting flange to further stiffen the mud flap body against horizontal (rearward) bending and deflection to reduce sailing and help maintain the mud flap body in place behind the vehicle wheels, in use. The fins and the vertical channels therebetween are effective to direct water incident upon the front of the mudflap down towards the road, rather than out to the side, and can also help reduce air turbulence for better aerodynamic stability and efficiency, in use.

In one particular aspect, the invention provides an injection molded mud flap with a front facing multi-layered, patterned structure comprising overlapping diagonal ribs and vertical vanes formed on a forward facing base sheet surface, wherein the vertical vanes protrude substantially greater than the diagonal ribs.

Embodiments of the invention allow for manufacture of a commercially appealing (meets requirements, branding opportunities) mud flap designed to combat durability (cracking around the mud flap mount and general toughness in use) and performance issues (sailing, deflecting material downwardly, stiffness without increased material/cost) while being cost effective to manufacture (single material, injection mold process).

### BRIEF DESCRIPTION OF THE DRAWINGS

The invention may be better understood from the following detailed description of embodiments thereof, presented by way of non-limiting example only and with reference to the accompanying drawings, in which:

FIG. 1 is a rear perspective view of a mud flap according to an embodiment of the invention;

FIG. 2 is a front perspective view of the mud flap according to a first embodiment;

FIG. 3 is a diagrammatic illustration of a mud flap mounted in relation to the wheels of a vehicle;

FIG. 4 is an enlarged view through vertical section A-A in an upper portion of the mud flap as seen in FIG. 1;

FIG. 5 is a front perspective view of the mud flap according to the first embodiment;

FIG. 6 is a rear perspective view of the mud flap according to the first embodiment;

FIG. 7 is a front plan view of the mud flap according to the first embodiment;

FIG. 7A is an enlarged view of a portion of the mud flap as seen in FIG. 7;

FIG. 7B is an enlarged view through section D-D of the mud flap as seen in FIG. 7A;

FIG. 7C shows a horizontal section through C-C of the mud flap as seen in FIG. 7;

FIG. 7D is an enlarged view of a portion of the section as seen in FIG. 7C;

FIG. 8 is a side view of the mud flap according to the first embodiment;

FIG. 9 shows a vertical section through B-B of the mud flap as seen in FIG. 7;

FIG. 9A is an enlarged view of a top portion of the mud flap section as seen in FIG. 9;

FIG. 9B is an enlarged view of a bottom portion of the mud flap section as seen in FIG. 9;

FIGS. 10 and 11 are front and rear perspective views, respectively, of a mud flap according to a second embodiment;

FIG. 12 is a front plan view of the mud flap according to the second embodiment;

FIG. 12A is an enlarged view of a portion of the mud flap as seen in FIG. 12;

FIG. 12B is an enlarged view through section E-E of the mud flap as seen in FIG. 12A;

FIGS. 13 and 14 are front plan views showing two mud flaps of different sizes, respectively towards the smallest and largest proportions that might be used commercially.

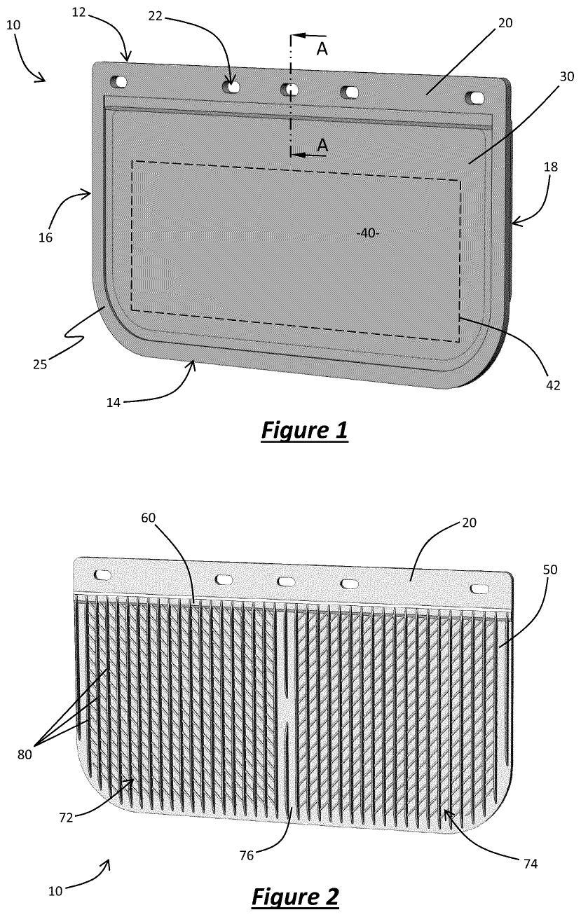

### DETAILED DESCRIPTION

In the following description, directional terms are used as if referring to a mud flap that is fitted to a vehicle. The front of the mud flap faces in the forward direction of the vehicle, and therefore faces the rear of the vehicle wheel it is mounted behind. The rear of the mud flap faces the same direction as the rear of the vehicle, and presents a surface that may be visible to road users behind.

Dimensions (expressed in millimeters) in respect of a number of features of the illustrated embodiments are indicated in the drawings. These dimensions should be considered as exemplary only.

A mud flap according to an embodiment of the present invention, for use on a truck or other vehicle, or for another application, is illustrated in the accompanying drawings. The mud flap is designated by reference number 10 and, in the illustrated embodiment, comprises a generally flat, rectangular-shaped member having a top edge 12, side edges 16 and 18 and a bottom edge 14. Rounded corners join the side edges to the bottom edge, for aesthetics and durability. This rectangular shape, however, is intended to be exemplary only as the mud flap could also be square-shaped or of any other shape appropriate for a particular application, and can have any aspect ratio of width to height as appropriate for the vehicle.

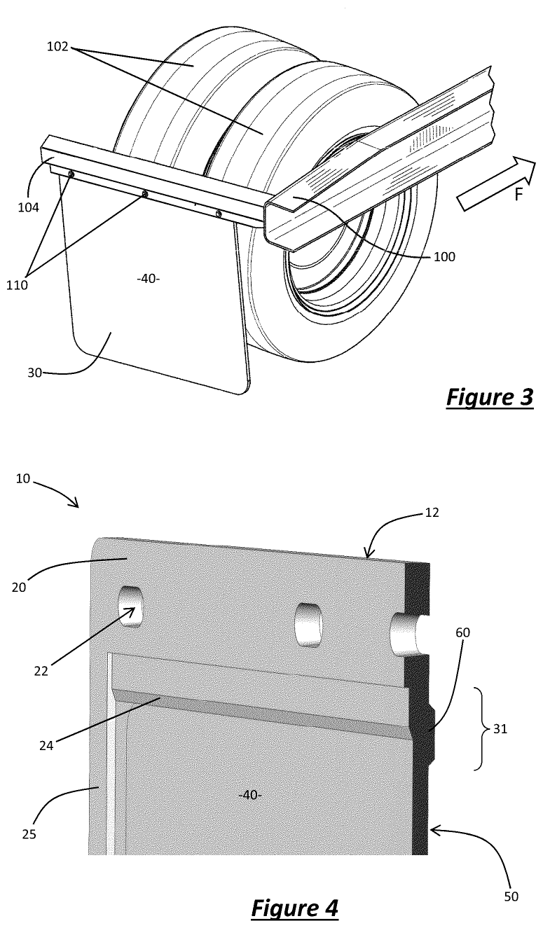

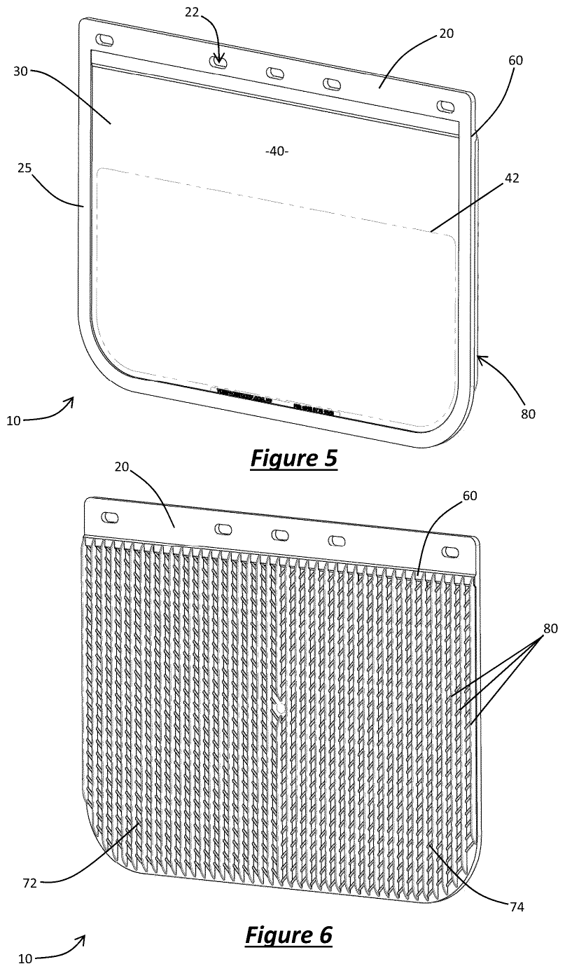

The mud flap 10 has a mounting flange 20 in the form of a flat strip of material extending across the top thereof, for the purpose of mounting it to a vehicle by means of mounting holes 22. The main body 30 of the mud flap 10 depends downwardly from the mounting flange 20 and is adapted to hang down from the vehicle, behind one or more wheels thereof. FIG. 3 diagrammatically illustrates a mud flap mounted on a vehicle, wherein the vehicle chassis 100 is carried on wheels 102, with the forward direction of travel indicated by arrow ‘F’. A sub-frame or other structure of the vehicle 104 is supported by the chassis, directly behind wheels 102, and has a plurality of apertures that align with the mounting holes 22, allowing the mounting flange of the mud flap to be secured thereto by way of fasteners 110. When mounted on the vehicle, the body 30 of the mud flap hangs down behind the wheels, with the rear surface 40 facing backward and the front face of the mud flap facing the rear of the wheels 102.

The mounting flange strip 20 has a substantially constant material thickness, matched in thickness by a peripheral border strip 25 that extends around the sides and bottom of the mud flap, forming the outer edge of the main body 30. The rear surface 40, within the bounds of the peripheral border 25, is recessed with respect to the surface of the mounting flange and peripheral border strips. Meanwhile, the front facing base surface 50 is substantially coplanar with the front surface of the mounting flange and peripheral border, with the result that the sheet material forming the main body 30 is thinner than the mounting flange (apart from around the peripheral edge). The rear face of the mud flap may, in practice, be formed with embossed lettering, logos or other decoration and/or advertising symbols, within the region indicated at 42 which corresponds to a mold insert that can be swapped and changed during manufacturing. In that case, the surface of the embossed indicia may be raised as far from the base surface as to be flush with the peripheral edge, surrounded by the recessed base surface 40. The rear surface 40, whether within or outside the region 42, may be additionally or alternatively printed, stamped or otherwise adorned

With the mounting flange 20 fixed to the vehicle and the body of the mud flap 30 unrestrained, the region 31 joining the body to the flange is typically subject to the greatest stresses as the mud flap body bends and flexes under the force of wind, water and impacting debris. In view of the direction of travel of the vehicle and the positioning of the mud flap directly behind the wheels, mostly the force of wind, water, etc. on the mud flap is applied from the front, such that the body of the mud flap predominantly bends and/or flexes rearwardly of the fixed mounting flange 20. Through the joining region 31, the mud flap 10 according to embodiments of the invention substantially maintains the material thickness from the mounting flange. As seen in the drawings, there is a small step reduction in material thickness at the lower edge (rear face) of the mounting flange, but the vertical transition from mounting flange material thickness to the thinner sheet material of the body 30 is otherwise relatively smooth and continuous across an obliquely angled fillet surface 24 (FIG. 4). Opposite the rear transition surface 24, the front of the mud flap 10 is provided with a strengthened region 60 of thickened material that extends in a horizontal band across the width of the mud flap. Vertically, the thickened band 60 extends from above the transition surface 24 to below the transition surface, strengthening the mud flap 10 in the joining region 31 which is subject to the greatest stresses during ordinary use. Sloped, fillet surfaces preferably join the thickened band 60 to the rear surface of the mounting flange at the top, and to the rear base surface 50 of the main body to avoid abrupt transitions of sheet material thickness in the joining region. The strengthening band 60, along with other features of the mud flap 10 as explained below, also help reduce sailing of the mud flap, in use, because the thickened band of material is not only stronger but stiffer against bending forces in the region where those forces are greatest felt by the mud flap.

Considered from the front, as seen in FIGS. 2, 6 and 7 for instance, the body 30 of mud flap 10 has a multi-layered structure of juxtaposed diagonal ribs 70 and longitudinally extending (vertical) vanes 80 formed on the rear base surface 50. Beneath the strengthening band 60, the rear surface 50 of the mud flap body is substantially planar. The diagonal ribs 70 and vertical vanes 80 are integrally formed with the mud flap body and project perpendicularly forward from the rear surface 50. The structure is multi-layered in that the ribs 70 and vanes 80 project forwardly from the rear base surface 50 to different extents, wherein the sheet material body 30 of the mud flap, the ribs 70 and the vanes 80 can be thought of as different layers, even if they are all integrally formed.

A mud flap 10 as shown in FIGS. 10 to 12 is provided with diagonal ribs 70 but not the aforementioned vertical vanes. This allows the ribs themselves to be seen more distinctly. According to embodiments of the invention the ribs comprise a pattern of evenly spaced, parallel strips of material raised from the front surface 50 and, collectively, covering substantially the entire front surface of the mud flap body 30. The height to which the ribs extend from the surface 50 is, in the illustrated embodiments, less than the thickness of the mud flap body sheet material. In the examples shown, the rib height (2.5 mm) is one half of the sheet material thickness (5 mm), but these dimensions and proportions should not be considered limiting. The ribs 70, according to this example, have a width about the same as their height and are spaced from one another by about 11 mm. The spacing between adjacent ribs can be selected according to requirements and, in some embodiments, may vary across different regions of the mud flap.

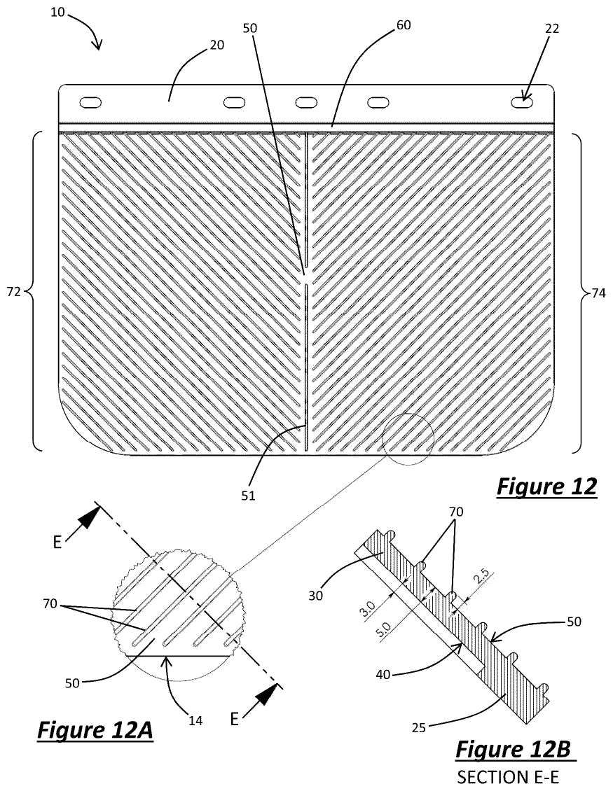

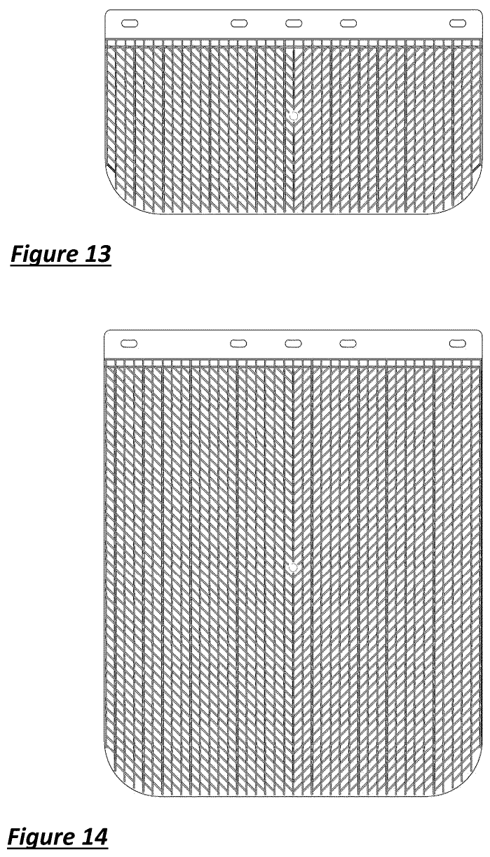

The ribs 70 extend across substantially the whole front surface of the mud flap body. They may have a uniform pattern across the entire surface or they may form different patterns on different parts thereof. For instance, in FIG. 12 the ribs 70 can be seen to have one pattern of ribs 72 on the right hand side of the mud flap and another pattern of ribs 74 on the left hand side. The left and right rib patterns, in this case, are both angled at about 45 degrees, but in mirror image symmetry about a central vertical rib 51. The angles of the ribs can be more acute or oblique than that and may, if desired, be formed with sets of overlapping ribs at different angles, such as in a cross-hatch pattern.

The layer comprising the diagonal ribs 70 on the front surface 50 of the mud flap is provided to help with absorbing impacts from stones and other road debris during use. The diagonal ribs also help to stop tear damage from propagating across the mud flap, from any side pull and/or impacts with fixtures or vehicles. The diagonal ribs can also help reduce sailing of the mud flap, in use, by proving additional stiffness to the mud flap body, as compared with plain sheet material. Moreover, the pattern(s) of the diagonal ribs can be employed to introduce additional stiffness to the mud flap body in a targeted manner. For instance, consider the mud flap 10 as shown in FIG. 10, wherein the pattern of ribs is such that the left and right sets of ribs 74, 72 are oriented to each angle from their respective side edge 16, 18 downwardly toward the bottom edge 14. Those skilled in the art will recognize that a sheet material with a pattern of parallel ribs will naturally have a greater stiffness against bending around an axis transverse to the ribs than parallel to the ribs. On that basis, the pattern of ribs 72, 74 shown in FIG. 10 will provide the mud flap 10 with increased resistance against rearward deflection at the bottom of the mud flap. Moreover, this pattern should provide the mud flap with marginally greater resistance against rearward deflection at the bottom center of the mud flap than at the corners, since the corners can deflect at an angle and bend about an axis parallel to the ribs. Allowing the corners of the mud flap to deflect rearwardly marginally more than the center in the face of wind and water during use can assist with aerodynamic stability of the mud flap 10 and reduce sailing and flapping.

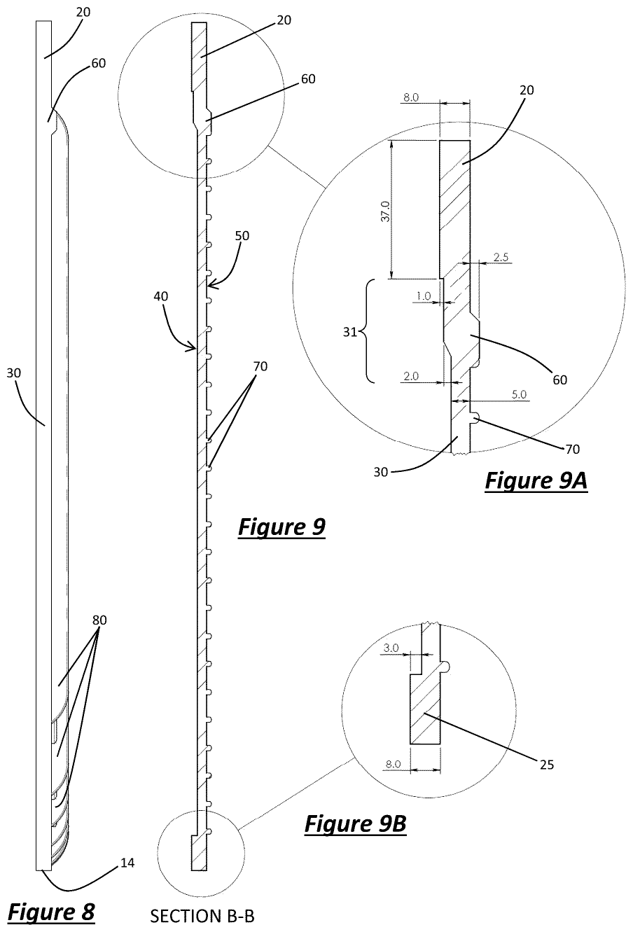

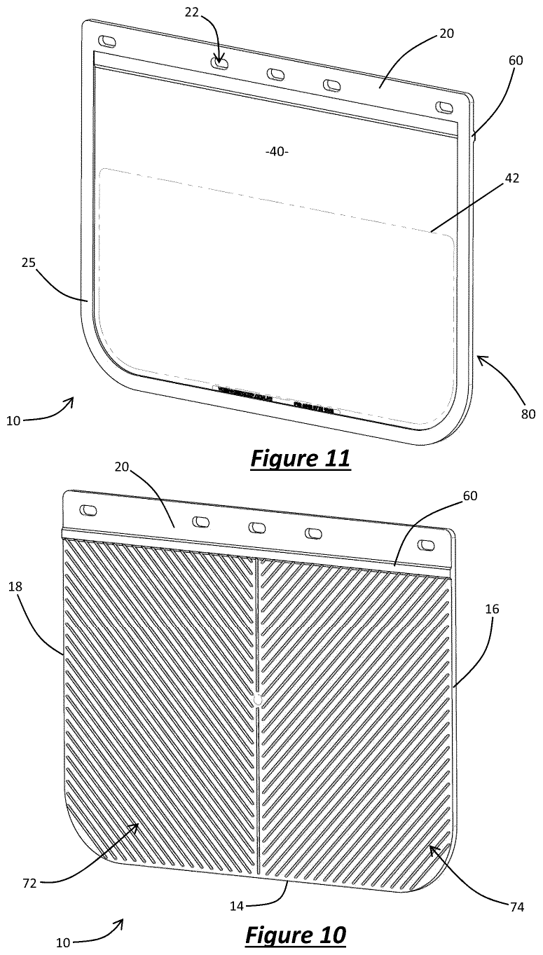

The vertical vanes 80 comprise a series of parallel fins that extend from top to bottom of the mud flap body. The top ends of the fins overlap the strengthening band 60 and curve to meet the bottom of the mounting flange 20. The bottom ends of the ribs also curve to meet the front surface of the mud flap, at or near the bottom edge 14. These features are best seen in FIG. 8.

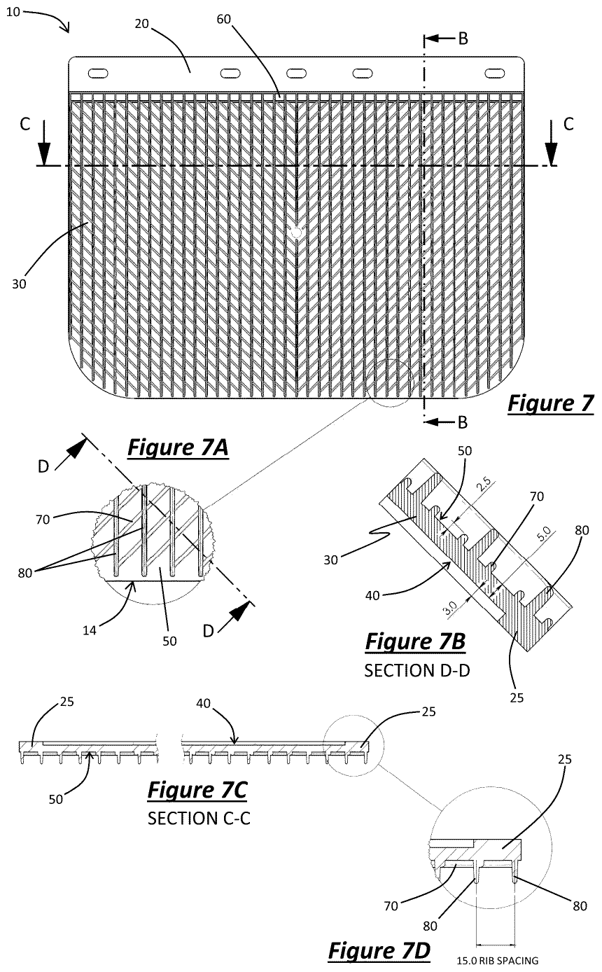

The fins 80 are equally spaced across the entire width of the mud flap front surface 50 of the mud flap body, as seen in FIGS. 7 and 7C. The equal spacing is for convenience, however, and is not essential to performance. The height to which the fins 80 extend from the surface 50 is greater than the height of the diagonal ribs 70, seen best in the cross-sectional depiction shown in FIG. 7B. In the illustrated embodiment the height of the fins is greater than the thickness of the mud flap body sheet material 30, and is commensurate with the thickness of the mud flap material at the peripheral flange 25. For example, the fins 80 may extend to a height of about 8 mm from the front surface 50, have a width of about 2 mm and be spaced from one another by about 15 mm.

Like the diagonal ribs, the vertical vanes also strengthen the front of the mud flap 10 against impacts, in use, and provide targeted stiffening of the mud flap structure. Since the fins run vertically, the mud flap structure has increased stiffness against bending about horizontal axes. This helps combat sailing of the mud flap 10, in use. The vertical channels that are formed between the adjacent fins 80 act to direct water downwardly and reduce spray to the side of the vehicle. The vertical fins and channels can also help to increase aerodynamic stability and efficiency of the mud flap 10, water or otherwise, by channeling air in the same manner.

The multi-layered mud flap structure as described hereinabove has a number of features designed for improved durability, performance and cost effectiveness. The structure of the mud flap where the body 30 joins the mounting flange 20, including the horizontal strengthening band 60 provides the mud flap with greater resistance to damage from repeated bending and flexing during use, and also increased resistance to rearward deflection of the mud flap body from bending near the top. The mud flap body 30 is constructed having a central sheet material with a thicker perimeter border 25 that is consistent with the mounting flange 20. This provides a stable overall shape and structure to the mud flap 10 when mounted to the vehicle, while maintaining relatively low material usage requirements. The sheet material of the mud flap body 30 provides a barrier against water and road debris from the vehicle wheels.

The diagonal ribs 70 comprise another layer, formed on the front of the mud flap body sheet material. The diagonal ribs layer aids in strengthening the mud flap against damage from impacts and tears without significantly increasing the amount of material required for manufacture of the product. The pattern(s) of diagonal ribs can affect the stiffness of the mud flap body in different ways according to their orientation. This can be used to tailor the mud flap stiffness, to some extent, for increased performance with respect to sailing and aerodynamic stability.

The vertical fins 80, where provided, comprise a third layer on the front of the mud flap 10. The vertical fins overlay the same area on the front of the mud flap as the diagonal ribs, but the fins project substantially further from the front surface 50 of the sheet material than do the ribs. The vertical fins stiffen the mud flap body against horizontal (rearward) bending and deflection to reduce sailing and help maintain the mud flap body in place behind the vehicle wheels, in use. The fins, and the vertical channels, therebetween are effective to direct incident water down towards the road, rather than out to the side, and can also help reduce air turbulence for better aerodynamic stability and efficiency, in use.

The mud flaps 10 according to embodiments of the invention are preferably manufactured by injection molding. The material may be a natural or synthetic polymer such as rubber or plastic, or any other suitable material as is known to those skilled in the art for such application.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

1. An injection molded mud flap with a front-facing, multi-layered, patterned structure comprising overlapping diagonal ribs and vertical vanes formed on a forward facing base sheet surface, wherein the vertical vanes protrude substantially greater than the diagonal ribs.

2. A mud flap comprising an injection-molded unitary body of flexible rubber or polymer material, the mud flap including a mounting flange at the top that is adapted for securing it to a vehicle and a generally planar mud flap body depending from the mounting flange, the mud flap body being attached to the mounting flange by a joining region that has strengthening band with increased material thickness extending horizontally across the width of the mud flap.

3. A mud flap comprising an injection-molded unitary body of flexible rubber or polymer material including a mounting flange at the top that is adapted for securing the mud flap to a vehicle and a generally planar mud flap body depending from the mounting flange, the mud flap body having a front face formed with a pattern of parallel ribs extending in a diagonal orientation across the front surface.

4. A mud flap according to claim 3, wherein the front of the mud flap body has different diagonally oriented patterns of ribs on the left and right sides thereof.

5. A mud flap according to claim 4, wherein the left and right patterns of ribs have mirror image symmetry.

6. A mud flap according to claim 3, wherein the mud flap body has a sheet material thickness, and the ribs protrude from the sheet material front surface to a height less than the sheet material thickness.

7. A mud flap according to claim 6, wherein the height of the ribs is about one half of the sheet material thickness.

8. A mud flap according to claim 3, wherein the front of the mud flap is provided with a plurality of integrally formed vertical fins spaced across the width of the mud flap and extending substantially from top to bottom.

9. A mud flap according to claim 8, wherein the vertical fins protrude from the sheet material front surface to a height substantially greater than the ribs.

10. A mud flap according to claim 8, wherein the mud flap body is attached to the mounting flange by a joining region that has strengthening band with increased material thickness extending horizontally across the width of the mud flap.

11. A mud flap according to claim 10, wherein the top ends of the vertical fins at least partially overlap with the horizontal strengthening band.
